(19) United States
(12) Patent Application Publication
(10) Pub. No.: US 2002/0105286 A1
(43) Pub. Date: Aug. 8, 2002

(54) Relatively movable illumination device for diverse visual effect

(76) Inventor: Greg Allyn Brownell, South Bend, IN (US)

Correspondence Address: Ryan M. Fountain, Esq., 420 Lincoln Way West, Mishawaka, IN, 46544, US

(21) Appl. No.: 09/753,369

(22) Filed: Jan. 2, 2001

(51) Int. Cl. G05F 1/00

(52) U.S. Cl. 315/291

(57) ABSTRACT

An illuminating apparatus is provided having a least a plurality of differently colored light sources, such as LEDs, a device for switching the light sources on and off and a device for controlling the rate of that switching so as to create trails of light within the range of persistence of vision of the viewer such that relative motion between the apparatus and the viewer varies the color, position, geometric shape and/or number of light sources as perceived by the viewer.

### BACKGROUND AND SUMMARY OF THE INVENTION

The present invention relates generally to light emitting devices used to create visual special effects for novelty items and entertainment. More particularly, the present invention relates to sources of illumination for that purpose that are movable relative to the viewer.

A wide variety of devices are known having illumination apparatus to create visual effects for the use and entertainment of the viewer. The present invention focuses on the phenomenon known as “persistence of vision” to create its visual effects. Persistence of vision is exhibited in human eyesight and causes images to appear to persist at a given location for a short duration after they are in fact removed. For example, streaks and trails will often appear to remain after viewing a bright light or photoflash. In addition, a limited “response time” of the typical human eye only allows us to see events lasting longer than a certain time period. For instance, we cannot see a fly's wing flap because it moves too fast.

These characteristics of human eyesight are generally known and used in a variety of ways. For example, a color television set takes advantage of these “limitations” through the use of timing. The “flying spot” from an electron beam cannot be seen as it sweeps across the colored phosphors of a picture tube because the eye does not respond fast enough. Instead, a full-screen color picture is perceived due to vision persistence.

With the present invention, an electronic colored-light “engine” produces changing colors when applied to moving objects. The colors change instantaneously relative to the viewer, so that sharply defined steps of color are apparent when the illuminated object moves past the viewer's field of vision, or when the observer's view shifts past the illuminated object. The present invention typically includes multiple colored light emitting diodes (LEDs) and a microcontroller running a software program that produces selected color patterns in a timed sequence. The present invention relies on timing to create the effect of trails of colored light. When the individual color LEDs are mixed together in time (time-multiplexed) at a fast enough rate, they appear as one combined color. When the rate slows below a certain point, the colors can be separated from one another by the motions of the light source past the field of vision.

This invention can be coupled to a light guide or diffuser to create various geometric shapes of light images, such a tubular, linear, spherical or edge-lit forms. Such optical light guides can be etched, engraved, molded or otherwise detailed with patterns or logos that cause the light to escape at specific points, to illuminate and highlight a desired image. This invention has application in novelty lighting effects, toys, decorative and fashion items, entertainment products, and many other commercial uses.

In summary, the present invention provides an illuminating apparatus having a least a plurality of differently colored light sources, such as LEDs, a device for switching the light sources on and off and a device for controlling the rate of that switching so as to create trails of light within the range of persistence of vision of the viewer such that relative motion between the apparatus and the viewer varies the color, position, geometric shape and/or number of light sources as perceived by the viewer.

### BRIEF DESCRIPTION OF THE DRAWINGS

FIG. 1 is a schematic representation of the preferred embodiment of the present invention, using a DC-DC converter, a microcontroller, NPN type transistors driving common-anode LEDs, an analog control input, and a pushbutton input.

FIG. 2 is a schematic representation of another embodiment of the invention, using a linear step-down regulator, a microcontroller, NPN transistors driving common-anode LEDs, a pushbutton, and a manual analog adjustment that controls the LED multiplex timing.

FIG. 3 is a schematic representation of still another embodiment of the invention, using a 5-volt DC input, a microcontroller, NPN transistors, common-anode LEDs, a pushbutton, and having no external input.

FIG. 4 is a schematic representation of yet another embodiment of the invention, using a 5-volt DC input, a microcontroller with direct drive of common-anode LEDs, and a pushbutton.

FIG. 5 is a schematic representation of yet still another embodiment of the invention, using a 5-volt DC input, a microcontroller with its outputs directly driving common-cathode LEDs, and a pushbutton.

FIG. 6 is a schematic representation of a further embodiment of the invention, using a 5-volt DC input, a microcontroller, PNP transistors, common-cathode LEDs, and a pushbutton input.

FIG. 7 is a schematic representation of a still further embodiment of the invention, using 5-volt DC input, a microcontroller, NPN transistors, common-anode LEDs, a pushbutton and a serial data input.

FIG. 8 is a schematic representation of a yet still further embodiment of the invention, using an input regulator, a microcontroller, NPN transistors, only two common-cathode LEDs, a pushbutton and a manual adjustment input.

FIG. 9 is a schematic representation of an audio microphone amplifier circuit that can be used to modulate the color bands by connecting to the analog input of FIG. 1.

FIG. 10 is a diagram of the LED multiplex timing to produce the primary additive colors red, green, and blue.

FIG. 11 is a diagram of the LED multiplex timing to produce white light with no significantly perceptible flicker, where the individual colors are multiplexed at a much higher rate.

FIG. 12 is a diagram of the LED multiplex timing to produce secondary additive colors cyan, magenta, and yellow.

FIG. 13 is a diagram of the LED multiples timing to produce red, yellow, green, cyan, blue, and magenta, in that order (interleaved mix of primary and secondary colors).

FIG. 14 is a diagram of the LED multiplex timing to produce red, yellow, green, cyan, blue, and magenta, in that order, with dark or “off” bands separating the colors.

FIG. 15 is an illustration of one type of light diffusing guide that may be used to combine the primary colors together.

FIG. 16 is an illustration of the perceived appearance of the light guide of FIG. 15 when it is illuminated by the present invention while not moving.

FIG. 17 is an illustration of how the changes in color appear with the motion of light guide of FIG. 15.

FIG. 18 is an illustration of a light-bulb application of the present invention, used to illuminate an area.

FIG. 19 is a sketch of a battery powered “glow-stick” type of application.

FIG. 20 is an illustration of a jewelry application, where the multi-colored LED is located at the end of a string of beads with a wire core, and a cut crystal jewel is illuminated by the LED.

FIG. 21 is a flow diagram of the main body of the microcontroller program of an embodiment of the present invention.

FIG. 22 is a flow diagram of the LEDs output portion of the control program for use with the embodiment of FIG. 21.

FIGS. 23a-c illustrate typical lens configurations for use with the present invention.

FIG. 24 shows a cross-sectional view of a typical pocket flashlight embodying the present invention.

### DETAILED DESCRIPTION OF PREFERRED EMBODIMENTS

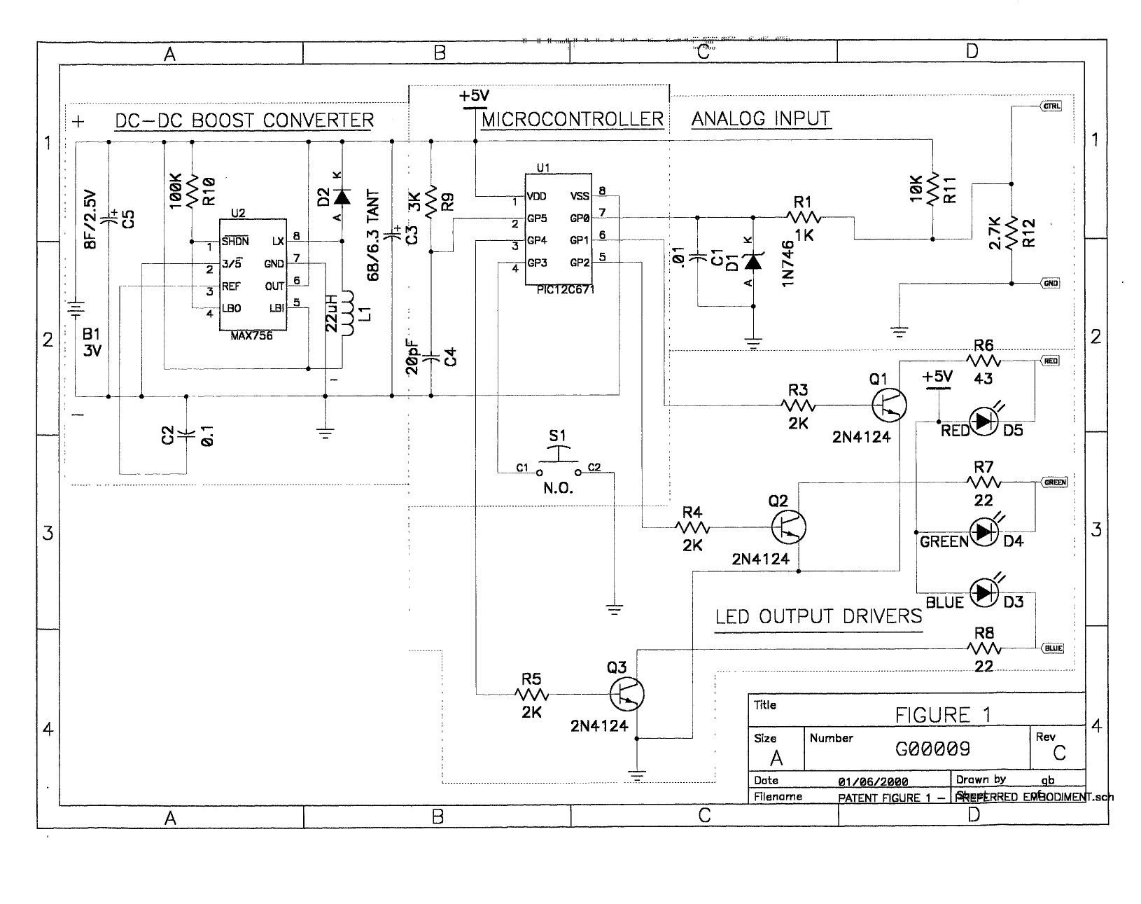

The circuit of FIG. 1 is preferably used in a portable illumination apparatus, hand held or worn, for example, by or on the user or viewer of the illumination. This circuit derives its power, for example, from a 3-volt battery B1, an optional 8-farad “ultra-capacitor” C5, or both. The ultra-capacitor has the ability to be repeatedly charged and discharged like a rechargeable battery but much faster and without the usual lifetime limitations. U2 is a boost converter IC that combined with its associated components, resistor R10, diode D2, and coil L1, steps the 3-volt input up to the 5 volts typically required by the microcontroller circuit, until the battery voltage drops below 2 volts, at which point U2 enters a shutdown mode by having its low battery out (LBO) pin connected to its shutdown (SHDN) pen. Pullup resistor R10 serves to provide a high logic level at the SHDN pin.

U1 is, for example, an 8-bit microcontroller, such as type PIC12C671 device which is commercially available from Microchip Technologies, Inc., having multiple input/output (I/O) lines and capable of executing an internally-stored control program directing its I/O lines. U1 can be configured to use its internal R-C clock oscillator to time the execution of its instructions, or to use optional E-C values R9 and C4 to externally set the oscillator frequency. In preferred applications of the present invention, the frequency of oscillation is typically 4 MHz, and R9 and C4 may or may not be used, as desired in a given situation.

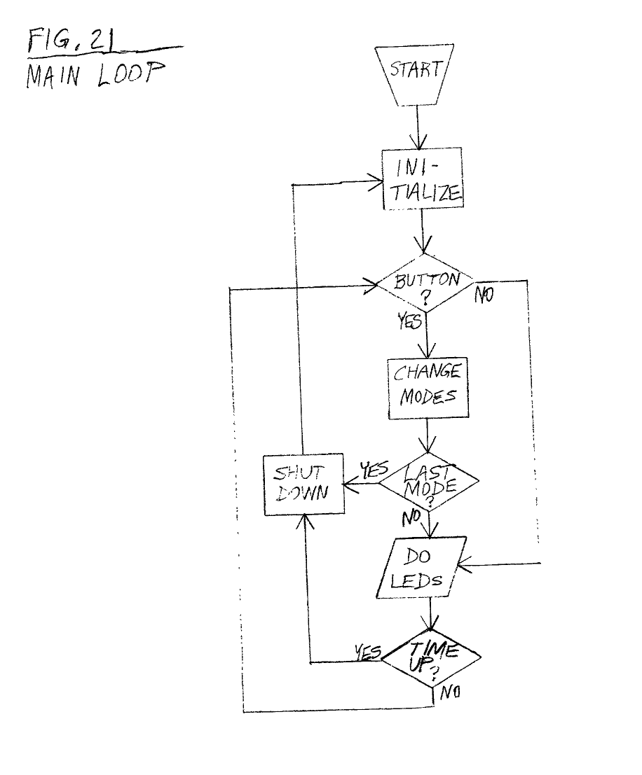

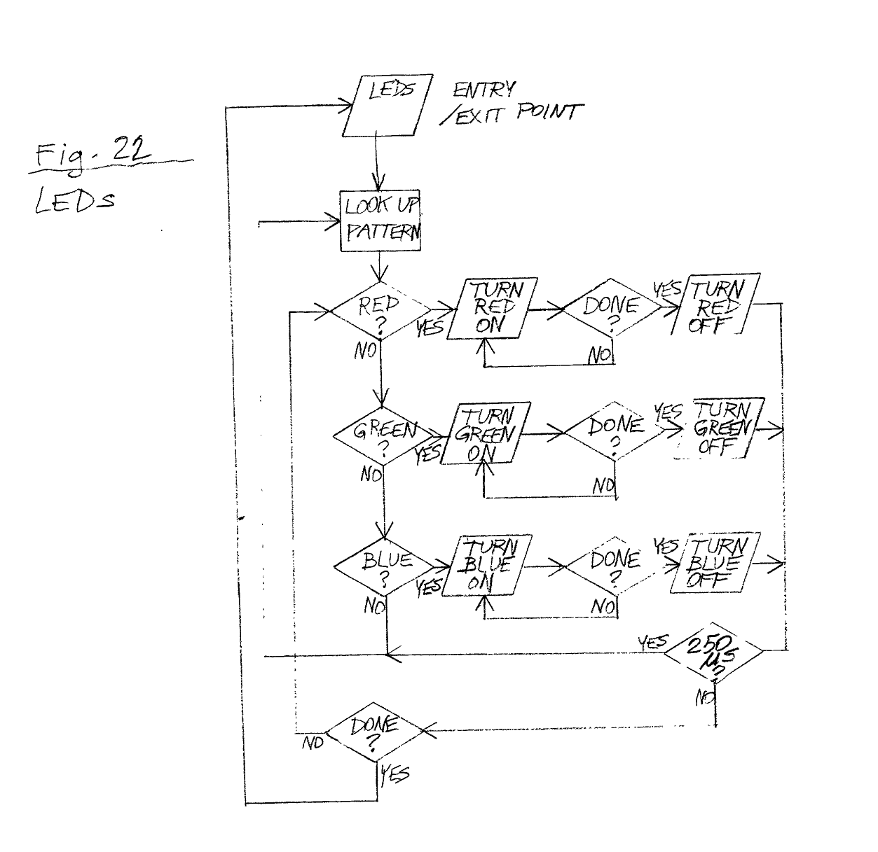

One of U1's I/O pins, GP3, is connected pushbutton S1, which signals U1 to advance to the next portion of its control program and initiate a new color pattern (refer to FIGS. 21 and 22). The color patterns are stored in a lookup table within U1's pre-programmed read-only memory (ROM). Another of U1's I/O pins, GP0, is preferably configured as an analog input which can accept variable-voltage signals and internally convert them into digital representations (analog-to-digital converter). This pin then accepts an external control signal from another circuit and uses it to control the LED timing. The signal level is preset by resistor divider R11 and R12 when there is no signal present. Resistor R1 and capacitor C1 serve to filter noise from the control signal, and zener diode D1 clamps the maximum voltage to a level below U1's typical maximum permissible input voltage of 5 volts.

Three more of U1's I/O pins (GP1, GP2, and GP4) are connected through resistors R3, R4, and R5, to the base terminals of NPN output transistors Q1, Q2, and Q3 respectively. These transistors are used to increase the available drive current to the LEDs above the Limit of U1's I/O pins. R3, R4, and R5, are chosen to balance the relative brightness of the 3 LEDs, allowing any color light to be produced by multiplexing the 3 primary proportions.

Transistors Q1, Q2, and Q3 are connected in a common-emitter configuration, with their collector leads connected through resistors R6, R7, and R8 to the cathodes of LEDs D5, D4, and D3 which are red, green and blue light emitting diodes, respectively. The LED anodes are common to the +5 volt rail. When U1 instructs I/O pins GP1, GP2, or GP4 to go high (logic “1” or +5 volts), the corresponding output transistor is switched on and sinks current though the LED and its current-limiting resistor. Since the LEDs are multiplexed, each color is typically on for less than 100% of the time, therefore the forward current through the individual LEDs can be increased beyond the normal limit, substantially increasing brightness.

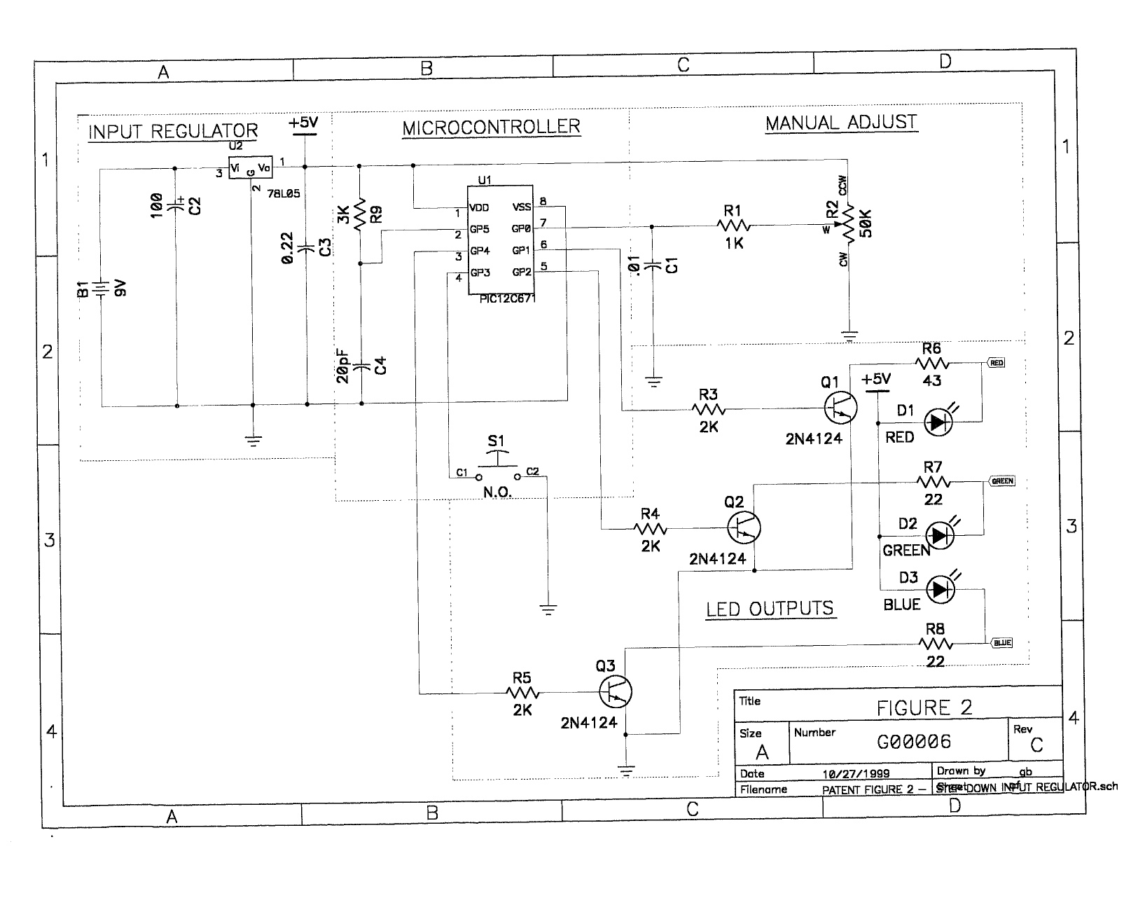

The circuit of FIG. 2 uses a 9-volt battery B1 and a low-dropout (LDO) step-down linear regulator U2, with its associated filter capacitors C2 and C3, to reduce the input voltage to the 5 volts typically required by the microcontroller U1. The LDO regulator can operate down to near the input voltage from the battery, effectively using the majority of the battery capacity while maintaining the 5 volts to the circuitry (when a 9-volt battery drops below 5 volts, its capacity is usually mainly depleted). Resistor R9 and capacitor C4 are optional clock oscillator timing components, used to set the oscillator frequency to some other value than the nominal 4 MHz of the internal clock oscillator.

In this circuit, the external analog input of FIG. 1 is replaced by a potentiometer R2 which is used to manually set the analog signal level by a knob, etc. The remainder of the circuitry is preferably the same as that of FIG. 1.

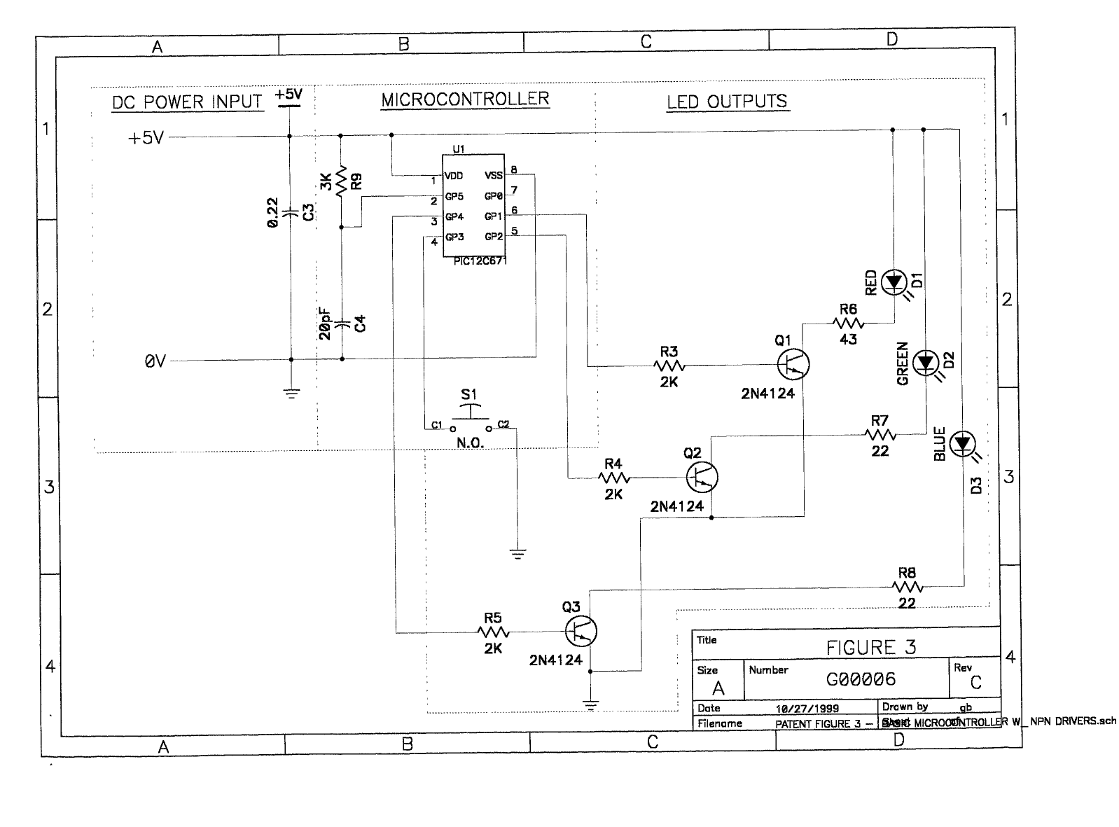

The circuit of FIG. 3 is the same as FIG. 2 except that it has no external input and is drawn without an input regulator for clarity.

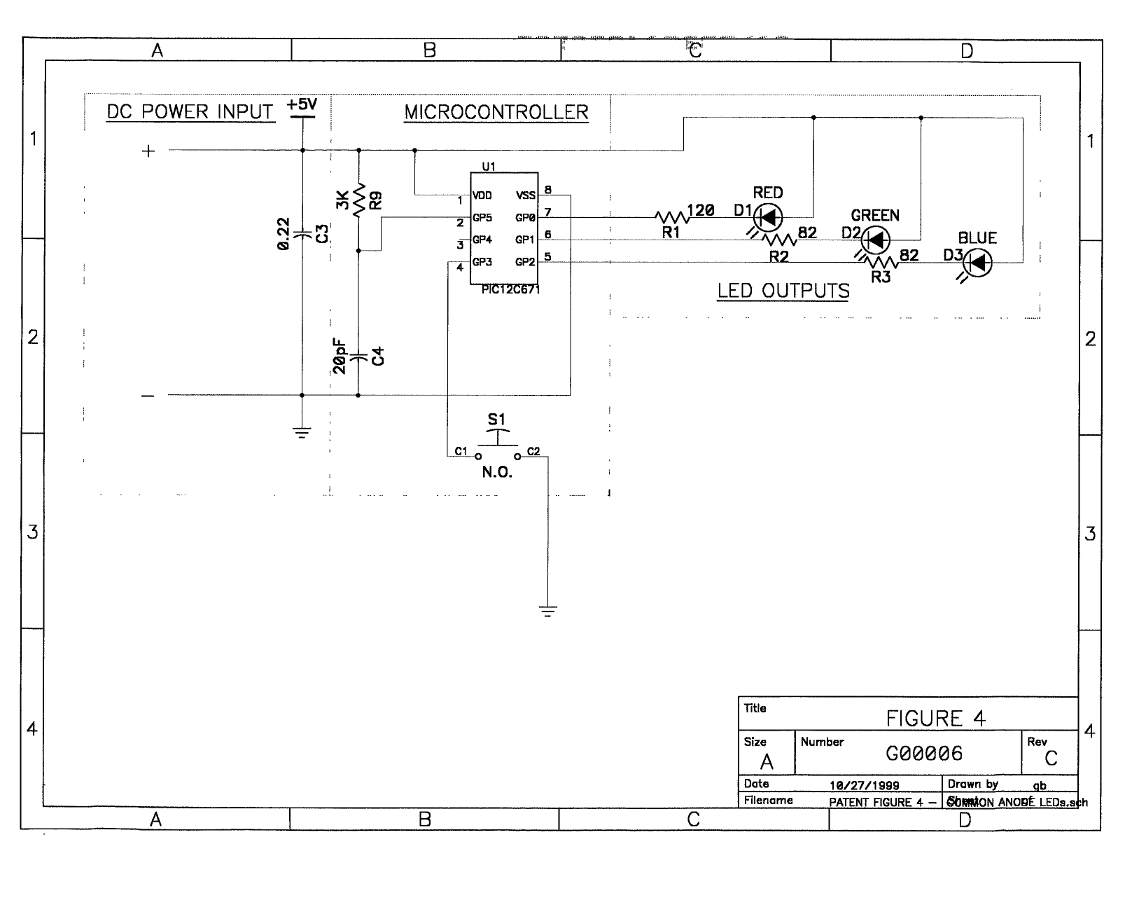

The circuit of FIG. 4 depicts direct connection of microcontroller U1's digital I/O pins to LEDs D1, D2 and D3 through current limiting resisters R1, R2 and R3. In this configuration, the LED intensity is, for example, limited to the maximum current-sinking capacity of the I/O pins.

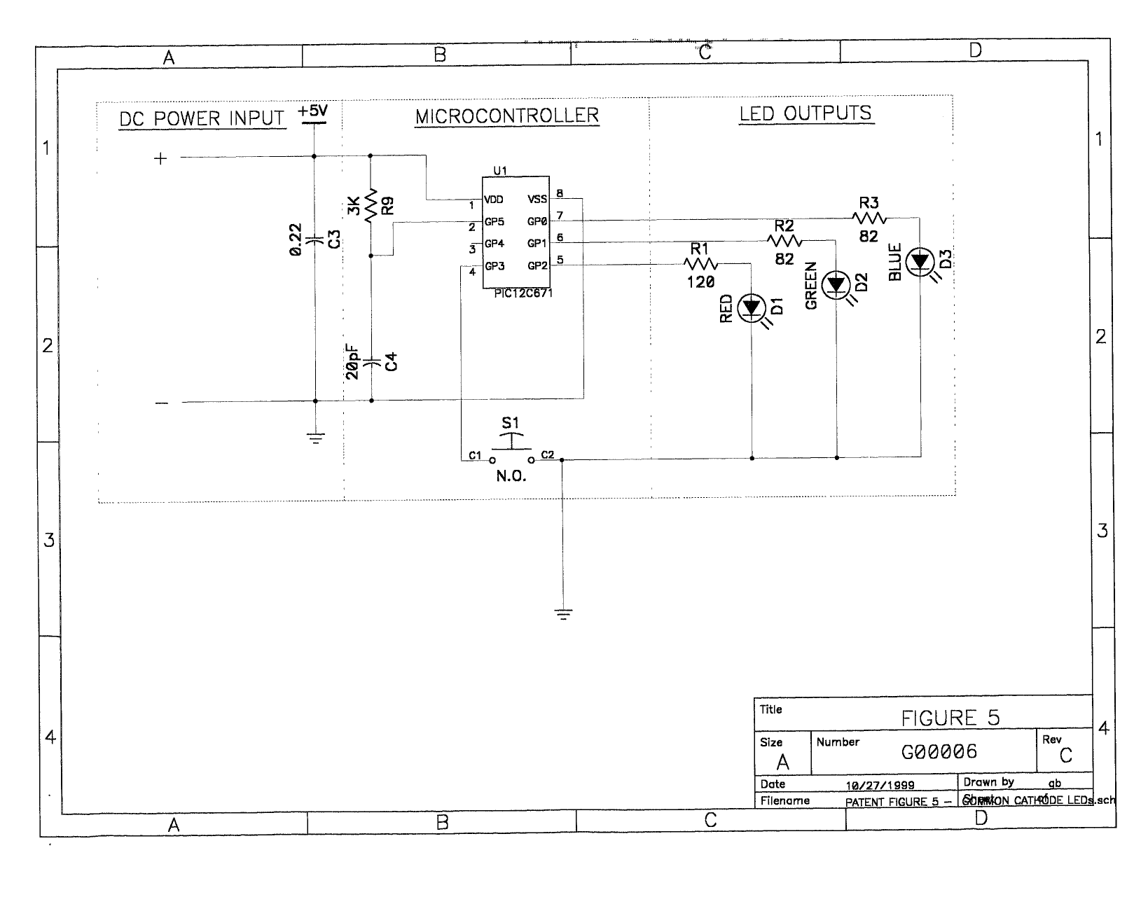

The circuit of FIG. 5 shows LEDs D1, D2 and D3 in a common-cathode connection, with the LED current set by resistors R1, R2 and R3, respectively. The LED current is also limited by the current-sourcing ability of U1′a I/O pins.

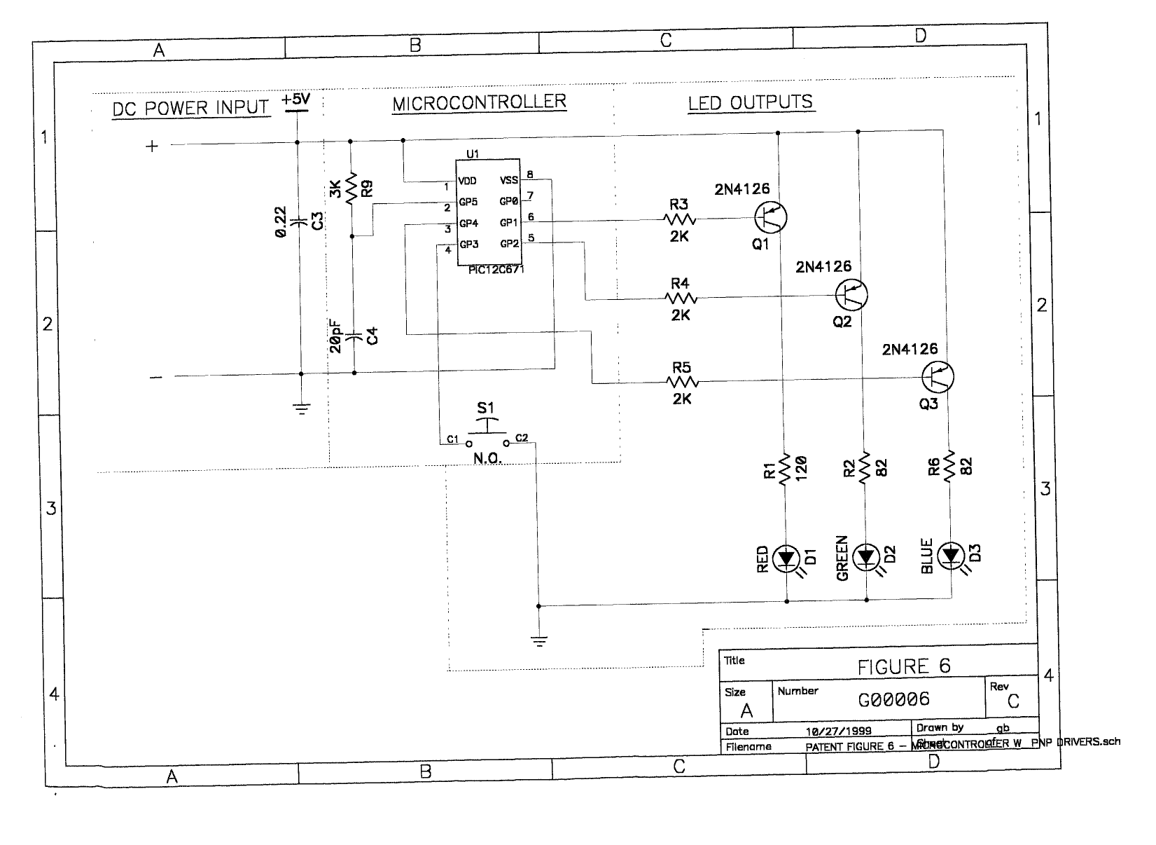

The circuit of FIG. 6 has LEDs D1, D2 and D3 connected through PNP driver transistors Q1, Q2 and Q3. In this configuration the I/O pins must typically be inverted in software because a low output turns the transistor ON instead of OFF.

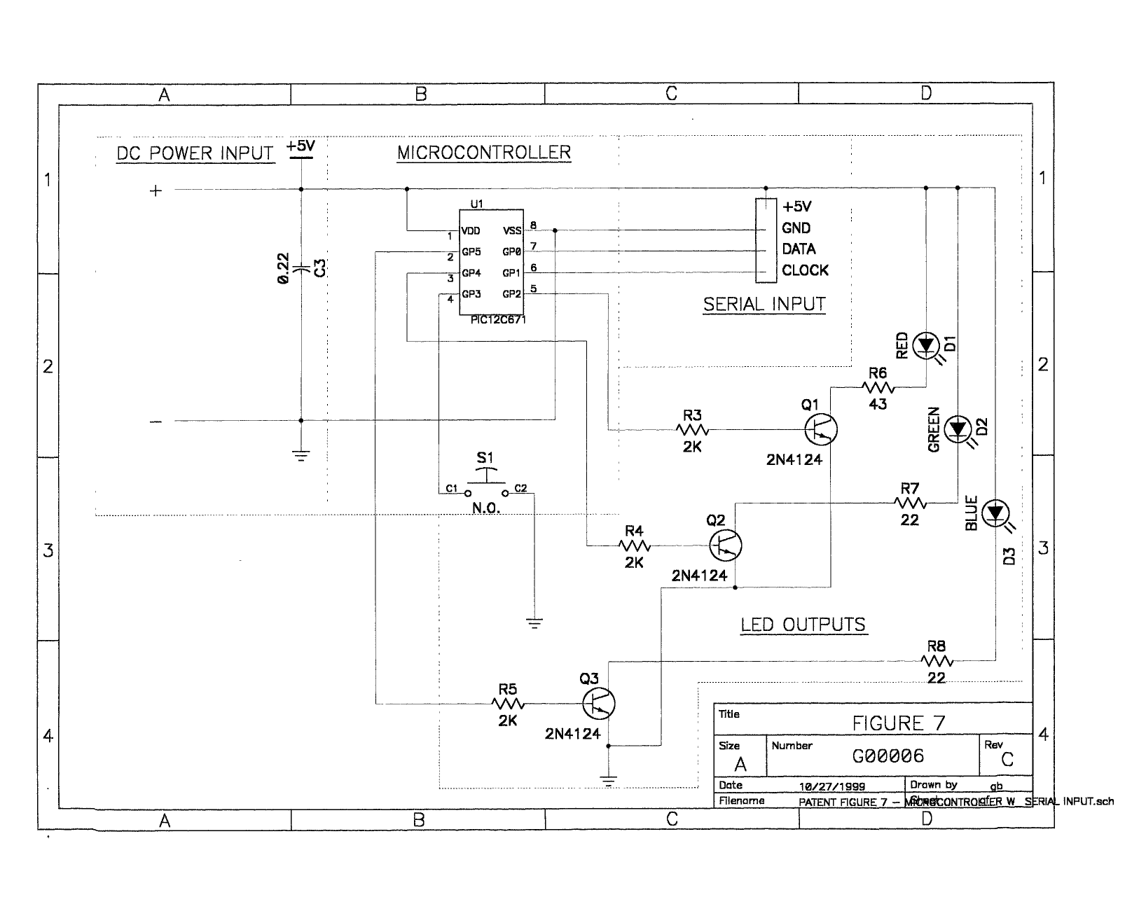

The circuit of FIG. 7 is similar to that of FIG. 3, except that some I/O pins have been rearranged to allow for a serial data input port. In this case microcontroller U1 can receive control instructions from an external data controllers via its data and clock lines GP0 and GP1.

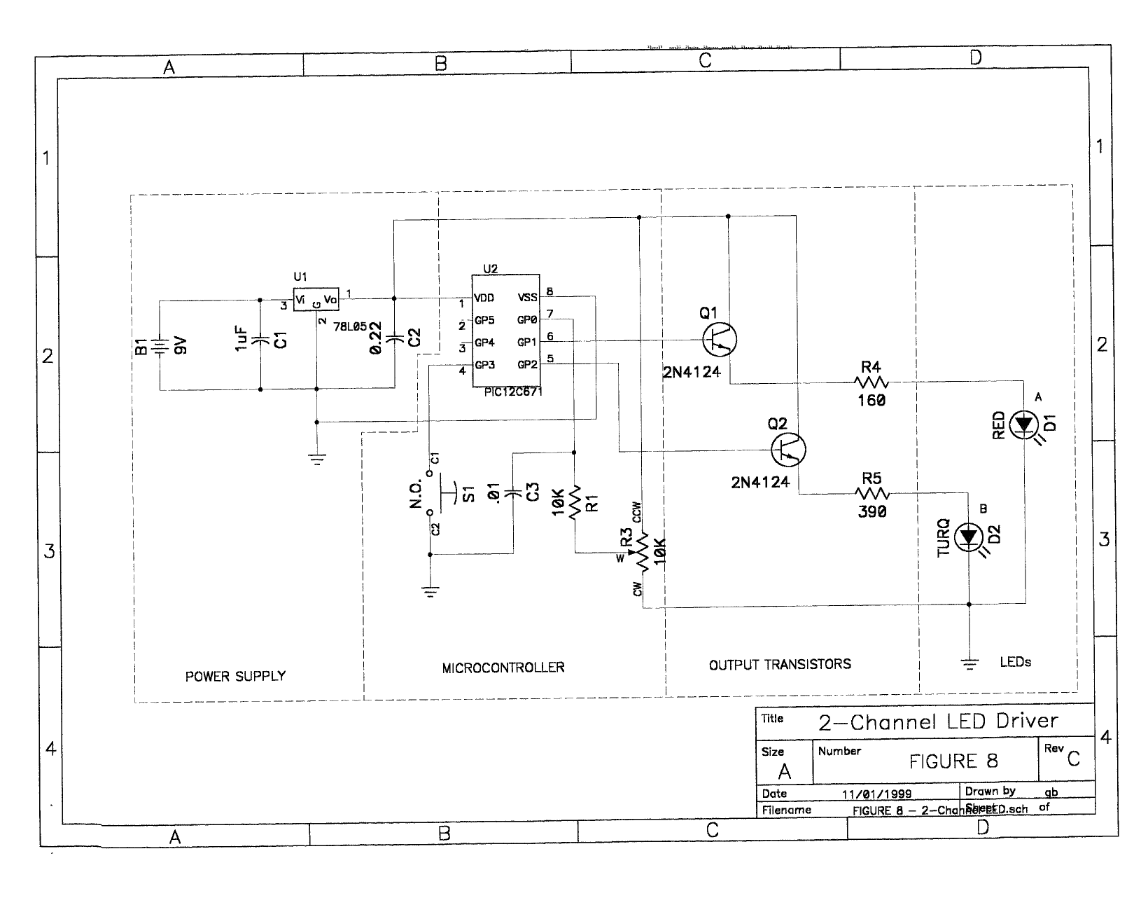

The circuit of FIG. 8 uses two colored LEDs, which may be located at opposite ends of a fiber optic light pipe designed to emit light through its side walls, to produce the appearance of colors “flowing” back and forth from one end to the other. It is shown using a 9-volt battery B1, a linear step-down regulator U1, a microcontroller U2, NPN transistors Q1 and Q2 in a common-collector configuration, and LEDs D1 and D2, shown as complementary colors red and turquoise.

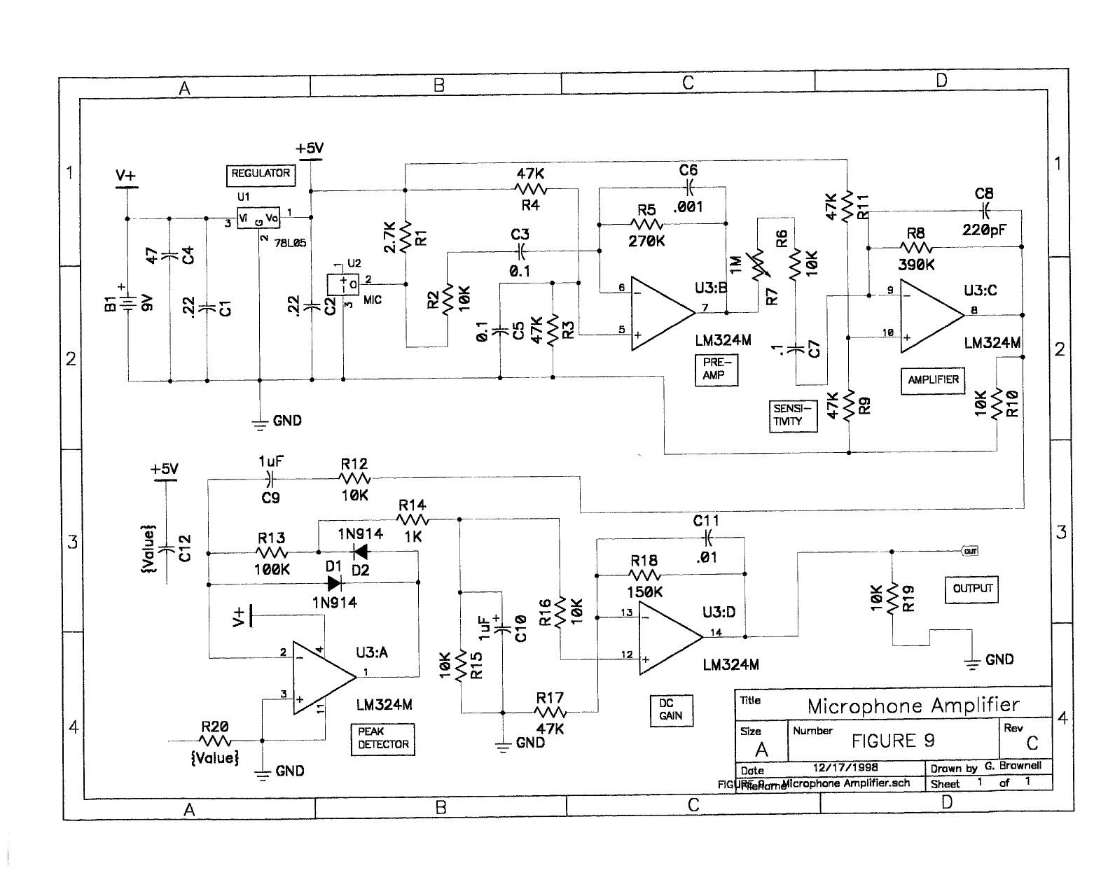

The circuit of FIG. 9 is an example of an audio microphone amplifier that can be used in conjunction with the circuit of FIG. 1 in a sound-controlled application. By connecting its output to the analog input in FIG. 1, the LED multiplex timing responds to changes in sound levels, creating a combined audio/visual display. In this particular embodiment, a peak detector is built into the circuit so that it responds to the loudest sounds and synchronizes with respect to that, the drum beat, for example.

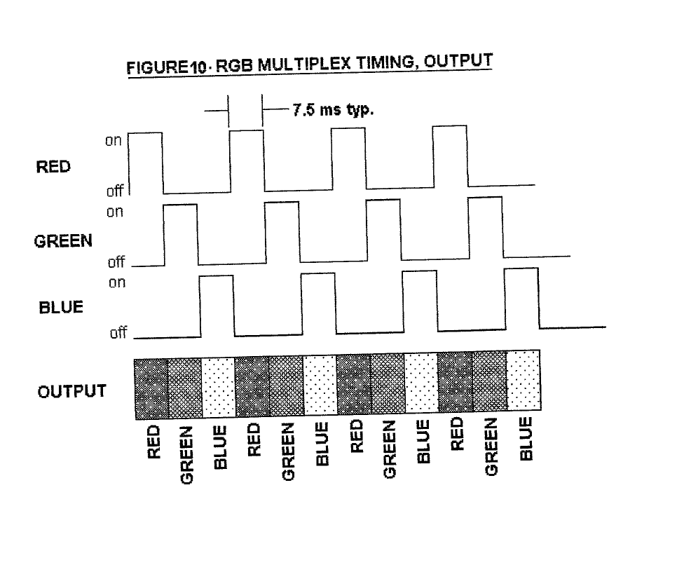

The timing diagram of FIG. 10 shows the multiplex timing of red, green and blue LEDs such that each primary color LED is on for only approximately ⅓ of the time, and will appear white to the typical human eye when it is not in motion. Each LED is sequentially on for 7.5 milliseconds, for a total cycle time of 22.5 milliseconds, producing a barely noticeable 44 Hz flicker. When the light source is moved across the field of vision, the colors visibly separate along the axis of motion, because the flicker is being spread out over a distance, allowing the viewer's eye to distinguish the individual color durations. If, for example, the object is moved at a rate of three feet per second, such as by waving through the air, in that 35 inch span one would expect to see a total of 133 individual color bands, each having a “width” of about ¼ inch. Slower multiplex rates widen the bands but increase the flicker.

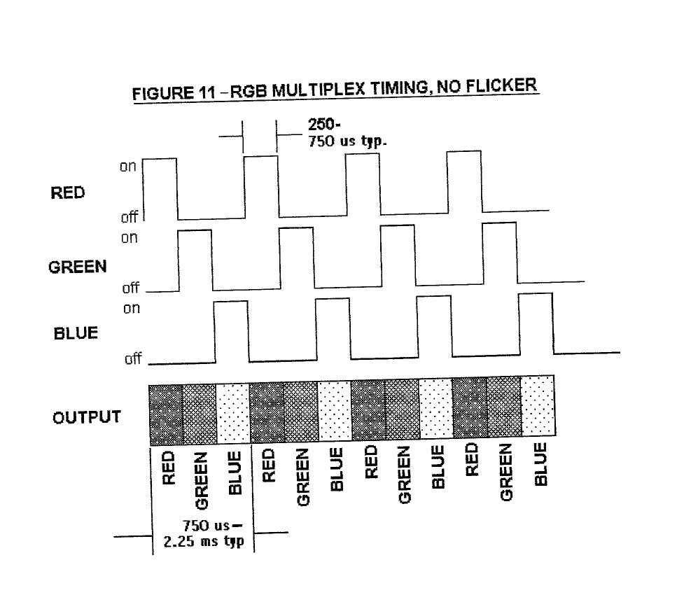

FIG. 11 shows the multiplex timing for the primary colors at an increased rate, so that the individual colors cannot be distinguished. The multiplex period shown is from 250-750 microseconds fo each color and from 750 to 2.25 milliseconds total cycle time for all three colors. This results in a scan frequency of from about 400-1300 Hz. The LEDs can easily switch at this frequency, but since the human eye cannot typically perceive events shorter than about 15 milliseconds, or about 66 Hz, the three primary colors blend smoothly into one flicker-free color. The proportional duration of each color may be varied relative to one another to produce colors other than white.

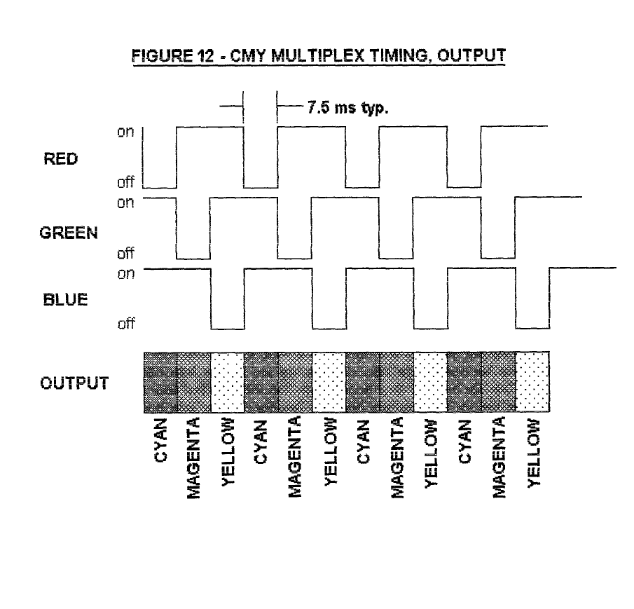

The diagram of FIG. 12 illustrates how the colors can be combined in pairs to produce the secondary additive colors: cyan, magenta, and yellow in discrete bands. Starting from the left, cyan is produced by the additive combination of blue and green, next magenta is produced by adding red and blue, then yellow is produced by the addition of red and green, then the 3-color cycle repeats. When the object illuminated in this way does not move, the resultant combination of secondary colors also blend into white. The total cycle time is 22.5 milliseconds, resulting in a slight flicker due to the 44 Hz scan rate. When the object moves, the colors separate across the field of vision.

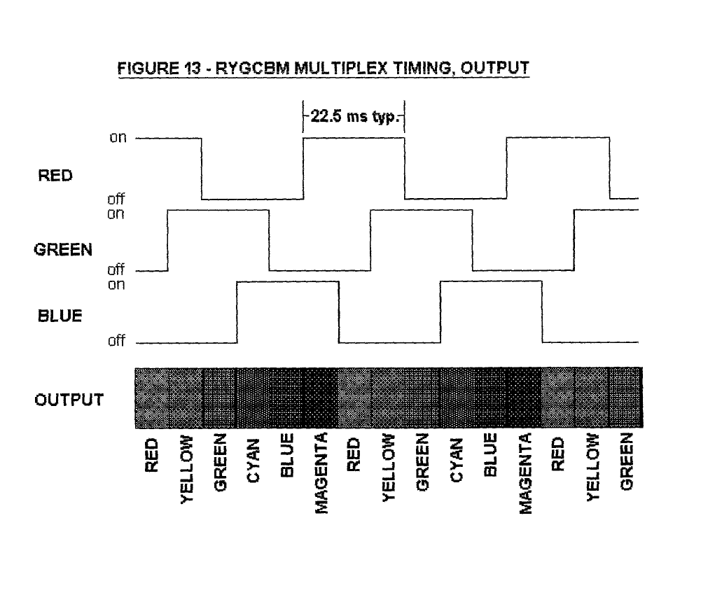

The diagram of FIG. 13 depicts the timing to product both primary and secondary color segments, by overlapping the primary pairs alternately with individual primary colors.

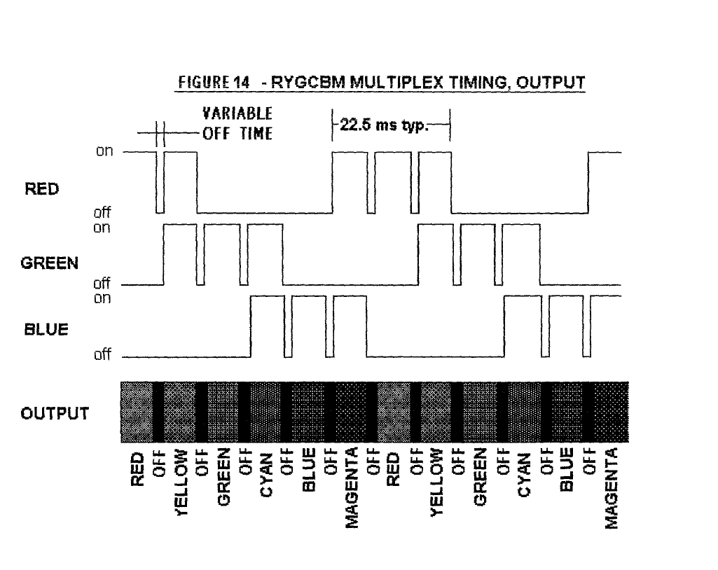

The diagram of FIG. 14 shows LED multiplex timing to produce bands of color separated by dark regions, where all LEDs are off. This diagram shows how the LEDs vary in time to produce red, then off, then yellow, then off, etc. The off time can be modulated by any suitable analog signal to vary the width of the color bands or the dark bands created by moving the LEDs.

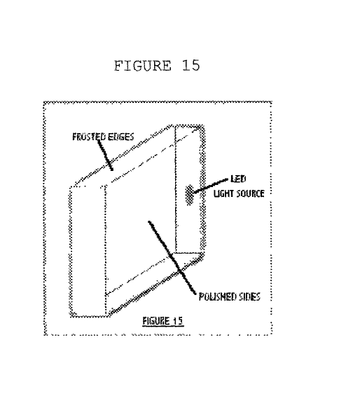

FIG. 15 shows an example of a diffusing lens that can be combined with the present invention to blend the individual primary colors into a single, uniform color. The lens is made of an optically clear material, such as acrylic, polycarbonate or glass. Many other lens geometries will perform the same function. The light source, in this case, a single LED package containing a red, green and a blue LED, is attached to one edge of the lens. Any of the edges may be clear and polished, frosted for diffusion or coated with a reflective material to guide the light in the desired direction.

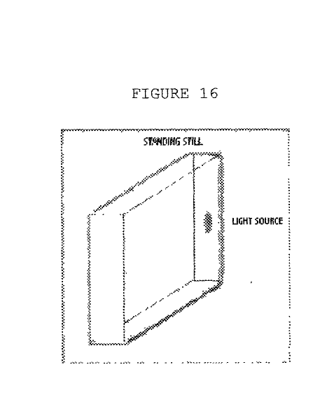

FIG. 16 shows the lens of FIG. 15, as illuminated by the circuit of FIG. 1, using the timing of FIG. 10, as it would appear with the apparatus standing still (static). The individual colors are not seen because of the rapid switching rate.

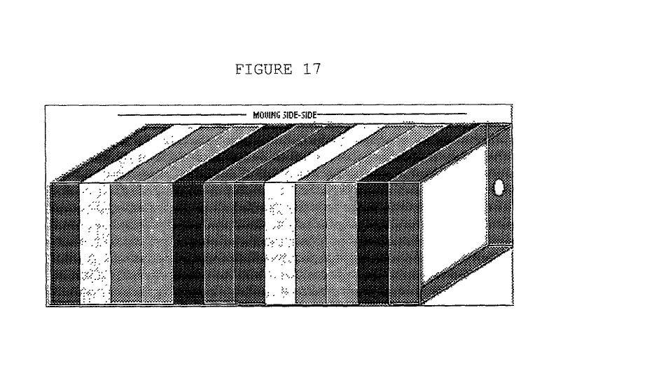

FIG. 17 illustrates the appearance of the lens of FIG. 15, illuminated by the circuit of FIG. 1 and using the timing of circuit 13, to produce 6 distinct colors as the lens moves along a horizontal axis. The discrete colors “fan out” as the lens moves, due to persistence of vision. The edges of the lens illuminate due to the diffusing surfaces, while the polished center section remains transparent.

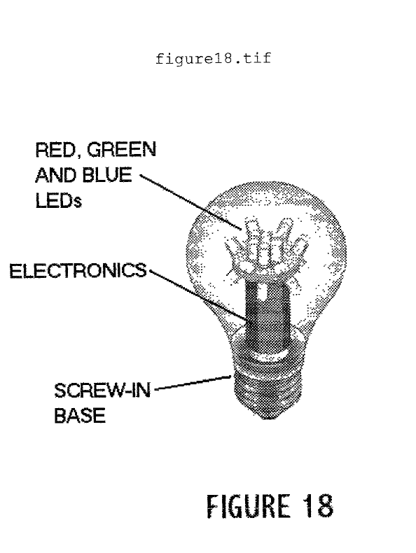

FIG. 18 illustrates an application of the present invention to an LED-based light bulb. Such decorative bulbs have been available in many colors and are commonly used in amusement park rides and other high vibrations environments where longer service life and higher durability is needed than more fragile glass incandescent lamps can provide. In this application of the present invention, an area is illuminated by the rapidly changing colors of light, and a moving person or object illuminated by this lamp also appears to change colors.

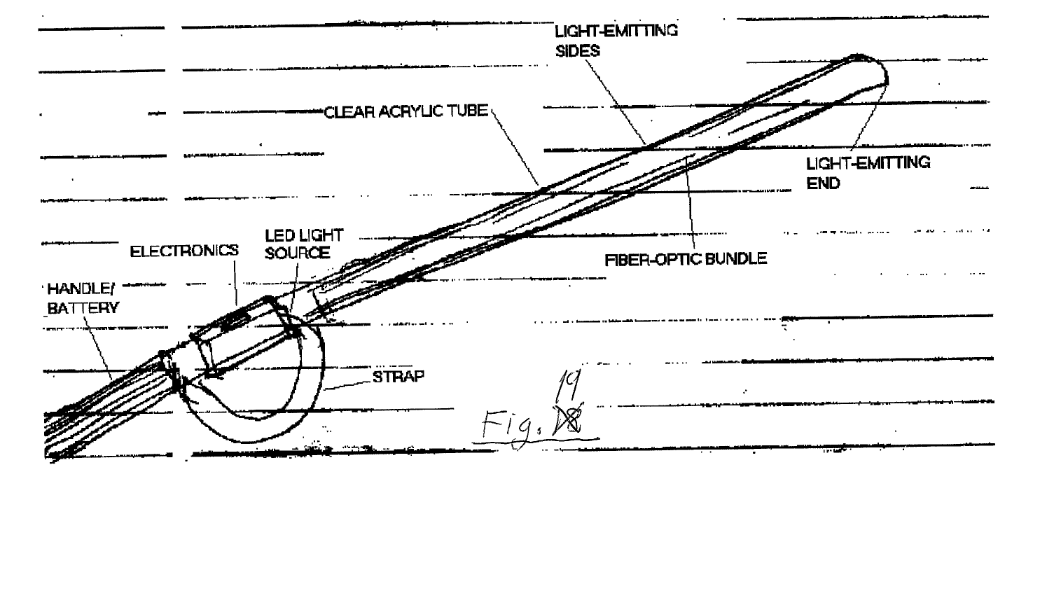

FIG. 19 shows a plan view of a battery-powered “glow-stick” incorporating the present invention, designed to be similar in appearance to chemical glow sticks, but with changing colors and a replaceable battery. The LED light source is piped along he acrylic tube wall to the end and emits light in all directions, especially at the end. The batteries, electronics and light guide may all be located inside the tube for streamlining.

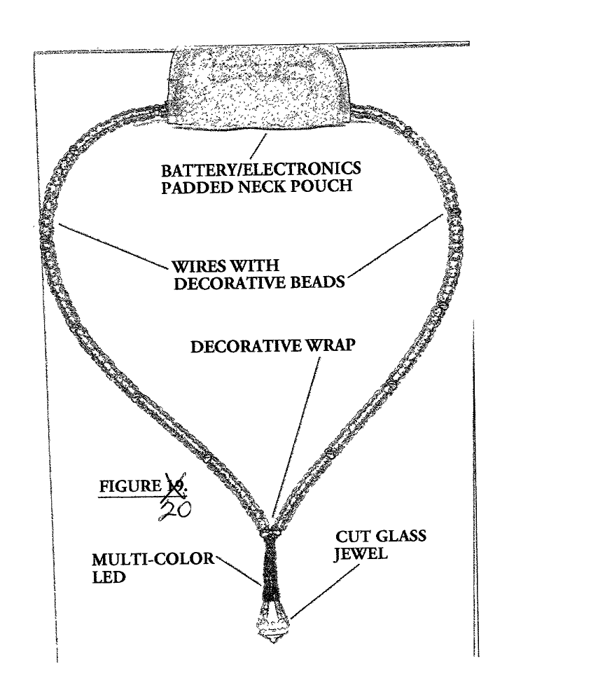

FIG. 20 illustrates another use of the present invention in a jewelry application. Here, the colored light shines from within a multi-faceted cut glass or crystal gem and highlights its edges. In this drawing the LEDs are located at one end of a necklace, and the battery and electronics are attached by wire cables, shown covered by beads, to the LEDs. A decorative wrap overs the electrical connections for aesthetic reasons.

FIG. 21 shows a flow diagram outline for the main body of the software control program residing within the microcontroller of FIG. 1. At the start, the program variables and counters are initialized, then the program waits for the pushbutton signal. Each successive push of the button causes the program to advance to its next color pattern or “mode,” where the selected color pattern is continuously produced until the last mode is reached or a preset time period expires, at which point the circuit turns off and becomes idle again. This section of the program calls on another section to control the LED timing, the “Do_LEDs” subroutine of FIG. 22.

FIG. 22 shows a flow diagram outline for the basic function of the LED timing section of the software control program. When this routine is called upon by the main program, it fetches the selected color pattern depending upon the selected mode, and sequentially switches the LEDs according to the specified timing. This example corresponds to the timing of FIG. 11, where only one LED is on at any given time and the multiples rate is high enough to eliminate any usual perceptible flicker. This routine begins and ends when the button is pressed. Many variables on this process are required to create the various predefined color patterns.

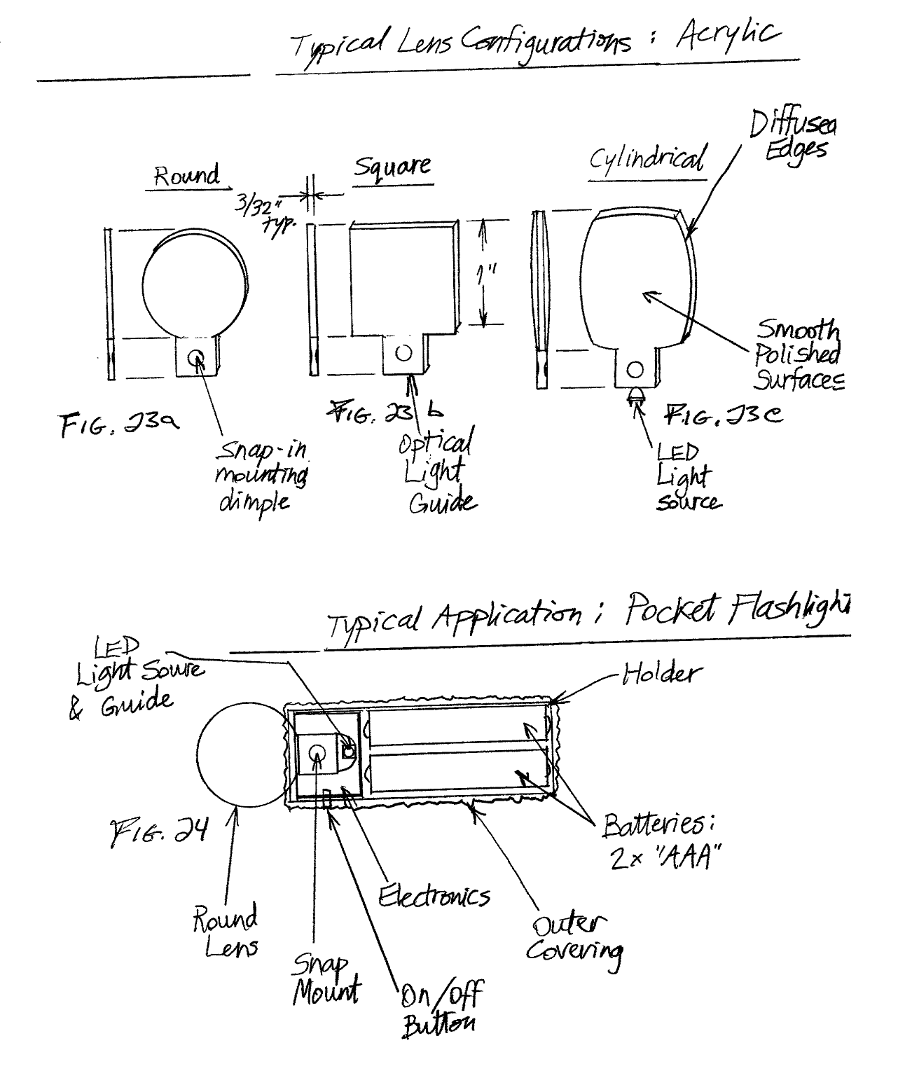

FIGS. 23a-c shows three alternative lens configurations for use with the present invention. These lens can be supplementally used as magnifying lens for view convience, when viewed through the polished surfaces of the lens, since the illumination provided by the present invention appears primarily through the diffused or frosted edges.

FIG. 24 shows an application of the lens of FIG. 23a with the present invention in combination with a pocket flashlight embodiment.

When microcontrollers of the type describe above are used with the present invention, programing can be accomplished by use of a Pic Start Plus model programming unit, commercially available from Microchip Technologies, Inc. In particular embodiments, all of the LEDs can be of the type mounted on a single chip.

In general then the present invention includes a light engine having various features, including: a plurality of differently colored light emitting diodes whose colors when combined will produce new colors, a microcontroller with pre-programed sequence instructions that steps the LEDs through colored patterns, a means of storing, recalling and displaying patterns of colored light, a means of producing color patters that can be seen when in motion, a means of modulating the color patterns by an external signal, and a portable power source for the LEDs and microcontroller, such as a battery. This light engine controls the patterns and brightness of the LEDs in such a way as to create a color pattern when the LEDs move relative to the viewer. The light engine can be used with optical light guides that collect and direct light to a desired locations and a light diffuser of etched or frosted surfaces that spread colors of light from the LEDs over an area and blend them together into one single color which lights up the diffuser surface.

The effect of the present invention is that relative motion between the illumination apparatus and the viewer can make the viewer perceive the illumination to be of different colors, different geometric configuration, different position, and/or of a different quantity, as compared to when the apparatus is not in relative motion.

Although the present invention has been described above in detail in specific embodiments, that was done by way of illustration and example and not as a limitation to the present invention. Those of skill in the art will now readily comprehend a variety of adaptations and applications for the present invention. Accordingly, the spirit and scope of the present invention are limited only by the terms of the claims below.

What is claimed is:

1. A movable apparatus having a plurality of light sources, a device for switching the light sources on and off, and a means for controlling the rate of switching so as to create trails of light within the range of the persistence of vision of the entity viewing the light sources such that the motion of the apparatus relative to the entity varies the color of the light as perceived by the entity.

2. A movable apparatus having a plurality of light sources, a device for switching the light sources on and off, and a means for controlling the rate of switching so as to create trails of light within the range of the persistence of vision of the entity viewing the light sources such that the motion of the apparatus relative to the entity varies the position of the light as perceived by the entity.

3. A movable apparatus having a plurality of light sources, a device for switching the light sources on and off, and a means for controlling the rate of switching so as to create trails of light within the range of the persistence of vision of the entity viewing the light sources such that the motion of the apparatus relative to the entity varies geometric configuration of the light as perceived by the entity.

4. A movable apparatus having a plurality of light sources, a device for switching the light sources on and off, and a means for controlling the rate of switching so as to create trails of light within the range of the persistence of vision of the entity viewing the light sources such that the motion of the apparatus relative to the entity varies the quantity of the light sources as perceived by the entity.

5. A light engine apparatus comprising:
a plurality of differently colored light emitting diodes, those diodes being selected such that the combination of light from two more of those diodes will produce light of a different color from the color of any of the component diodes,
a microcontroller having a preprogramed timing sequence instructions that step the LEDs through colored patterns.

6. The apparatus according to claim 5 also including means for controlling the timing sequence so as to create trails of light within the range of the persistence of vision of an entity viewing the diodes such that the motion of the apparatus relative to the entity varies the color of the light as perceived by the entity.

7. The apparatus according to claim 6 also including means for controlling the timing sequence so as to create trails of light within the range of the persistence of vision of an entity viewing the diodes such that the motion of the apparatus relative to the entity varies the position of the light as perceived by the entity.

8. The apparatus according to claim 7 also including means for controlling the timing sequence so as to create trails of light within the range of the persistence of vision of an entity viewing the diodes such that the motion of the apparatus relative to the entity varies the geometric configuration of the light as perceived by the entity.

9. The apparatus according to claim 8 also including means for controlling the timing sequence so as to create trails of light within the range of the persistence of vision of an entity viewing the diodes such that the motion of the apparatus relative to the entity varies the quantity of the light sources as perceived by the entity.
